(19) United States
(12) Patent Application Publication
(10) Pub. No.: US 2020/0128756 A1
(43) Pub. Date: Apr. 30, 2020

(54) METHOD OF PLANTING GRAFTED TEAK (TECTONA GRANDIS) TREES

(71) Applicants: Giang Yuke Ming, Vancouver, CA (US); Balraj Mann, Vancouver (CA)

(72) Inventors: Giang Yuke Ming, Vancouver, CA (US); Balraj Mann, Vancouver (CA)

(21) Appl. No.: 16/448,831

(22) Filed: Jun. 21, 2019

(30) Foreign Application Priority Data
Oct. 24, 2018 (VN) 1-2018-04733

(51) Int. Cl. A01G 2/30

(52) U.S. Cl. CPC A01G 2/30

(57) ABSTRACT

The invention discloses method of planting a grafted Teak (Tectona grandis) trees and belongs to the technical field of tree planting. The first step of planting method is preparing the seeds and creating initial Teak trees. Secondly, seven different species of trees including Poulownia trees, Pine trees, Western white pines, Azobe trees, Red wood trees, White cedar trees, Soft maple trees are grafted onto the initial Teak trees to create the grafted Teak trees. Next, the grafted Teak trees shall be taken care to adapt to the environment. After that, the grafted Teak trees shall be sterilized and planted in the nurseries. Finally, the grafted Teak trees shall be moved to the farm for large-area planting. The method of planting brings advantages of seven grafted trees into the grafted Teak trees, including high survival rate, fast growth, straight and large diameter trunk, high quantity, light weight, waterproof, heat resistance and good resistance against termites, flexibility and fire resistance, adaptation to harsh soil conditions and bad climate.

### CROSS-REFERENCE TO RELATED APPLICATIONS

The present application claims priority to Vietnamese Patent Application No. 1-2018-04733 field on Oct. 24, 2018, which is incorporated herein by reference.

### TECHNICAL FIELD

The present invention relates to a method of planting grafted Teak (Tectona grandis) trees by grafting different species of trees onto the ordinary Teak trees, namely, a method of preparing seeds and grafting 7 different types of trees into the Teak trees, the result is to create a grafted Teak trees having advantages of grafted trees including high survival rate, fast growth, straight and large diameter trunk, high quantity, light weight, waterproof, heat resistance and good resistance against termites, flexibility and fire resistance, adaptation to harsh soil conditions and bad climate.

### BACKGROUND ART

Several basic characteristics of grafted trees are as follows.
Characteristic of the Paulownia trees:

The Paulownia trees are big and fast-growing type of tree. Paulownia wood is more valuable than the Forkienia wood because Paulownia wood is very sturdy and the weight is light with a density of 0.265 g/cm3, high bearing capacity, no warping, slow burning capacity. Therefore, Paulownia wood is used to build yachts and to make high-end interior decorations. In addition, Paulownia wood also contains high portion of cellulose (46-49%), hemicellulose (22-25%), lignin (21-23%), hence, it is preferably chosen as materials for some important industries, such as: industrial alcohol production, energy supply source for fuel and production of pulp for cash printing. This type of tree grows very fast. In Vietnam, after 3 years of growth, the trees can be exploited. The more Paulownia tree grows, the more the amount of timber can be harvested. During the growth, a Paulownia tree can absorb a large amount of CO2, about 1,235 tons of CO2/year/ha. Planting Paulownia trees on a large area of land also prevents global warming and contributes to the restriction of rising sea level in the future. The heat resistance of Paulownia trees is very high. Paulownia leaves are hairy so they can keep dust, smoke and reduce environmental pollution.
Characteristic of the Pine trees:

The Pine trees are a wood type of tree that can be easily transplanted and grows very fast. These characteristics make the Pine trees become an ideal candidate for landscaping and applying to windscreen. The Pine trees is a high value hardwood type of tree, it prefers moist environment and soil having drainage ability.
Characteristic of the Western white pine tree:

The Western white pine is a pine species found in western mountainous areas of the United States and Canada, especially in Sierra Nevada region, Cascade Mountains, Coast Mountains and north of the Rocky Mountains. The tree extends down to sea level in many areas, particularly in Oregon and Washington. Western white pine (Pinus monticola) is a large tree, regularly growing to 30-50 m (98-164 ft) and exceptionally up to 70 m (230 ft) tall. Its characteristics are fast growing branches and widely planted. Western white pine grows strongly in many types of environment, from peat to dry soil, sand or rock.
Characteristic of the Azobe trees:

Azobe trees belong Fabaceae family, genus Erythrophleum, species of Erythrophleum fordii. Azobe tree is a very sturdy and heavy tree species that is invulnerable to termites. The tree's color is brown or maroon. The tree has good compressive strength and waterproof. The texture of the wood is fancy twisted, if the wood is left in the atmosphere for long time or is soaked in the mud, the color of wood texture turns to black. Wood is not warped, cracked, deformed due to weather, so it is very popular in making doors, paving floor and stairs and other household appliances.
Characteristic of the Red wood trees:

Red wood tree is also known with another name is Afzelia xylocarpa (scientific name) This tree species has light red heartwood, prominent black texture that looks almost like the skin of a tiger so people usually call it red wood trees or tiger's skin wood. Red wood tree prefers sunlight, suitable for planting on plateaus or flat hills with no submerged. Red wood's weight is quite heavy, the density of 0.80-0.85 (15% humidity). This type of wood is very sturdy, wood's texture looks very beautiful and long lasting, termite resistance, waterproof, etc., so it is suitable for processing and polishing, used for floors, doors, stairs, etc. or art carved furniture products.
Characteristic of the White cedar trees:

Cedar tree's tall is around 30-40 m (sometimes up to 60 m) with a pungent aroma of wood resin, pyramid-shaped top, and bark with cracks, wide and flat branches. The tree has various types of twigs, long twigs form pillars of branches and short twigs carry leaves. Cedar tree is adapted to the mountainous climate, where they receive raindrops in the winter and drought in the summer It has antibacterial and insect-resistance properties.
Characteristic of the Soft maple trees:

Maple is a large tree, which is mainly grown in cold-tropical areas. Soft maple (red maple) wood looks quite similar to sturdy maple wood but it is lighter, softer and less durable than sturdy maple wood. The sapwood of the maple is usually white with a slight reddish-brown color, the heartwood is light reddish brown, but sometimes quite darker. The soft maple sapwood is usually about 3-5 inches thick (approximately 76-127 mm). Soft maple is an important source of sawn timber and wood pulp. Soft maple is used in the manufacture of furniture, veneers, tables, cabinets, plywood, wine barrels, baskets, floor liners and railway connecting bar.
Characteristic of the Teak trees (Tectona grandis):

Teak is a large tree, with the scientific name is Tectona grandis, belonging to Verbaceae family. When living in the optimal environment, the tree can be more than 30 m tall with the trunk diameter of 60-80 cm. Tree stump often divides into many segments and spread in large area in order to firmly stand in steep terrains. Tree's bark is gray-yellow, with narrow and small cracks which become longer when the tree grows up. Young branches have square edges and are covered with rust-colored hair. Teak leaves have various shapes i.e. oval, inverted egg or nearly round; 20-60 cm of length, 20-40 cm of width; sharp top, stalked bottom; the upper the leaves is smooth, the underside is covered by pale yellow hair; stalk is 2-5 cm for length and covered with hair. Teak flower includes many small and white flowers. Teak fruit is spherical, its diameter is about 2 cm. Teak tree perfectly grows in fertile and well-drained soil with tropical climate. Teak tree demands much sunlight, fresh and clear area. Teak tree can be propagated by buds or seeds. The trees can survive in forest fires and anti pests but its resistance against the cold temperature is quite weak. Multi-purposes can be exploited by the Teak trees namely the ability to produce wood and fuel materials, embellishing the landscape, providing tannins, dyes and medicinal herbs.

Teak trees appear in India, Myanmar, Laos and Thailand. They have been imported to Vietnam since 1950s and grown in many provinces including Dong Nai, Binh Duong, Tay Ninh, Dac Lac, Son La, Lai Chau, Phu Tho, Tuyen Quang, Bac Can. Teak trees can be propagated by seed or stump method from natural regeneration sources. Recently in Dong Nai Province of Vietnam, there are technical norm for teak forest planting No. TCN 5-81, 38/QD-KT, Dec. 1, 1982, La Nga Forest Enterprise. This is a quite complete norm and widely applied in many places in Vietnam. Since there is no improved variety and planting process, in recent years, Teak forest quality is not high. The productivity of Teak plantations in Vietnam is still low (912 m³/year), the inner area is only 1,500 ha while other countries are much higher, for example: Indonesia is about 1,760 thousand hectares, India is about 2,450 thousand hectares, Myanmar is about 139 thousand hectares, Malaysia is about 4 thousand hectares, Thailand is 836 thousand hectares. Currently, seedlings and procedure for planting by seeds are commonly used but do not meet the needs of afforestation with high quality requirements. Moreover, the old propagation method also caused the separation of traits because free pollination makes the crop uneven, leading to fluctuating forest productivity. There was also a clonal propagation solution with cuttings, but this method is difficult because the rooting rate was not high, only 24-30%.

There are several tree grafting methods such as germ transplant, stump transplant, branch grafting, wedge grafting, segment grafting, . . . with other types of fruit trees or timber trees, however, there is no synthetic way to combine the said grafting methods to collect the advantage points of each grafted tree to create a new grafted tree. Therefore, method of planting grafted Teak by grafting several species of timber trees onto the Teak tree will create a graftedTeak trees with outstanding advantages, adapting to the environment and have high economic efficiency. Also, the grafted Teak trees require technical treatment to adapt to different conditions of environment so that the trees can grow faster.

### SUMMARY OF DISCLOSURE

The purpose of the invention is to plant an ordinary Teak tree, which is grafted with several different types of timber trees to create a grafted Teak tree that has outstanding advantages, adapt to the environment and have high economic efficiency.

In order to achieve the above purposes, the invention provides a method of planting grafted Teak (Tectona grandis) trees including the following steps:
Step 1: preparing the seeds and creating initial Teak trees.
Step 2: grafting the baby Teak trees with 7 different species of trees namely the Poulownia trees, the Pine trees, the Western white pines, the Azobe trees, the Red wood trees, the White cedar trees and the Soft maple trees.
Step 3: taking care the grafted Teak trees so that they can adapt to the environment.
Step 4: sterilizing and planting grafted Teak trees in nurseries.
Step 5: moving the grafted Teak trees into farm.

The different points of this invention is that an ordinary Teak tree is grafted with several different types of timber trees to create a grafted Teak tree that has outstanding advantages, adapt to the environment and have high economic efficiency.

In other respects, the invention provides the steps of adapting the Teak tree before being moving it to the nursery and using liquid of Anolyte to sterilizing the trees (step 3 and step 4). The method under this invention has given the good percentage of trees that are able to adapt and grow in different soil areas.

### DETAILED DESCRIPTION

In order to grow faster, the Teak trees prefers moisture soil to dry soil, accordingly, the trees is suitable for areas with an average annual rainfall from 1,250 to 2,500 mm, combined with a marked dry period of 3-5 months. Temperatures for better growth and development of Teak trees are 27° C.-36° C. during the day and 20° C.-30° C. at night. Under natural conditions, this species perfectly grows in localities having temperature fluctuates by seasons, from 13° C. (in the coldest months) to 40° C. (in the hottest months). The Teak trees demand high light and are suitable with range of light intensity from 75-95% during the day.

The invention provides a method of planting a grafted Teak (Tectona grandis) trees including the following steps:
Step 1: preparing the seeds and creating initial Teak trees.
Step 2: grafting the baby Teak trees with 7 different species of trees namely the Poulownia trees, the Pine trees, the Western white pines, the Azobe trees, the Red wood trees, the White cedar trees and the Soft maple trees.
Step 3: taking care the grafted Teak trees so that they can adapt to the environment.
Step 4: sterilizing and planting grafted Teak trees in nurseries.
Step 5: moving the grafted d Teak trees into farm.

### Step 1: Preparing the Seeds and Creating Initial Teak Trees

Choose 25-45-year-old Teak trees in the transformed type forests or recognized type forests to collect seeds. The mother tree is a tall, straight tree, symmetrical foliage, without pests and diseases, with little tumors. The seeds shall be collected within February-March when the fruits are ripe, their covers are slightly yellow, brown, light gray. After that, cover of the fruits is cleaned, dried, remove small seeds and infected seeds. Big seeds having 0.8-1 cm in diameter shall be chosen and kept in dry place. It it preferably to immediately sown the big seed because the germination rate is higher. 1 kg of seed is equivalent to about 2,000 seeds.

Choose flat, drainage soil which is near main roads and has protection fence to make nursery. Nursery soil must be plowed 3 times to be porous. Make beds with 1 m width, 10 m length. Soil of the beds must be crushed, picked up grass, reduce the sour by using lime if necessary. Soil of the beds is fertilized with manure about 4-5 kg/m². Within 1-2 weeks before sowing, sowed soil must be sterilized by liquid Benlate 1% or liquid Bi58 1% and water 1 liter of liquid per m².

Put seeds in bags, then soak in 80-100° C. water for 14-15 hours, take out, wash to remove sour, sun exposure. Soak and dry like that for 4 continuous days and then sow into soil. Sow seeds in the beginning of the spring or the beginning of rain season.

The seeds are sowed in 20 cm-apart slits, distance between seeds are 4-5 cm and then are fully covered by the soil; scattering method can be applied, however, it takes more grains and the baby trees need to be pruned to adjust density; depending on each area, straw or dry grass can be used to maintain moisture, if the straw or dry grass are not used, it is required to water the seeds twice a day; after sowing, the soil must be kept moist; then, the seeds shall germinate after about 1 month with a rate of 30-35%.

Water must be daily provided to maintain moisture, continuously for the first 1.5 months; then, water once per 2-3 days; clear weed and break clods 2 times/month, prune and move the baby trees from density place to sparse place; from the 6th month to the 10th month, water provide to ensure the moisture once a month; taking care for 2 months before planting; baby trees are resistant to pests and diseases, however, if pests and diseases appear, appropriate medicines in the market can be used.

### Step 2: Grafting the Baby Teak Trees with 7 Different Species of Trees

A bud of the ordinary Teak tree is grafted into the neck of a root of a 2-year-old Western white pine tree, the grafting process is maintained in complete darkness place to create the change, misty moisture is provided stimulate the development the grafting process.

When the 1-year-old baby tree reaches 1 cm diameter of the neck of roots, 0.5 m tall, stable, no pests and diseases, water to soften the soil an then use shovel to gently lift the baby tree, avoid crushing the tree or or its barks. Using a sharp and thin knife, deflect flat to tighten, cut beveled angle 30-45° in the vertical direction, at a point of 3-4 cm from the neck of the root and do not crush the trees.

Cut the leaf blade and keep only the petiole, use a specialized knife to take the sprout with about 2 cm in diameter (taking leaf bud as the center). In term of handling Soft maple embryo, take a knife to make a T-shaped groove into the place where is the junction of the grafting on the shell (do not touch the wood body). Then take the knife carefully and pry out the sides, put the sprout in, cover it by the cloth outside but open the grafted part.

Teak rootstock is grafted with Paulownia by branch grafting method, namely, select grafted eye of Paulownia branch to graft into the body of Teak tree. The Paulownia branch should have similar size to the Teak rootstock, then, scrape two grafted parts (1.5-2 cm length and 0.4-0.5 cm width) and put them close together. Use a thin nylon wire to fasten the grafted spot. When the upper grafted part is bigger than the lower part (it means that the grafted spot is attached), cut off the top of the rootstock and cut Paulownia branch with 2 cm away from the grafted spot. Now, the top-removed-rootstock will nurture the grafted eye part to develop a new grafted tree that has the outstanding characteristics of Paulownia tree.

After the second graft, wait until the tree grows up to 20 cm. On the rootstock, at a height of 30 cm above the ground cut off the top of the rootstock. Select an Azobe grafted branch with a diameter similar to the diameter of the rootstock; make a cut with 2-2.5 cm length, with 2-3 sleeping germs. Split a groove on the rootstock which has width and depth of the cut similar to the grafted branch.

Install the grafted branch into the rootstock with the outer layer of the rootstock and grafted branch are matched and wrapped up by thin nylon wire. Firstly, wrap a lot of rolls to fix the grafted branch on the rootstock, then spread the nylon wire and cover fully around the grafted branch, fix the rope knot at the rootstock. After grafting for 15-20 days, take care of grafted baby tree which begins to grow throughout the wire.

After the third graft, wait until the tree grows up for more 20 cm tall. On the rootstock, cut off branches of its canopy in the proper position, select the graft branch of Pine tree and cut both sides to form a wedge shape. Split the rootstock and install the graft branch with the outer layer of the rootstock and grafted branch are matched. Use nylon wire to tightly fix the grafted branches with the rootstock and seal the grafted branches to prevent evaporation. After the grafting branch pops out its buds, there are 1-2 good stable buds for growth, then cut the grafting wire. Take care of post-transplant plants like other grafting methods.

The next step is to graft with Red wood tree when the grafted tree grows 1.5 years old and then similarly graft with White cedar tree when it grows up for more 30 cm tall.

### Step 3: Taking Care the Grafted Teak Trees so That They Can Adapt to the Environment

This step is to adapt a grafted Teak tree to external conditions, prevent the socking for the tree when it is taken from an optimal and full of nutrients environment to autotrophic environment that the plant must synthesize nutrients from nature to grow up. The qualified baby grafted trees shall be brought to the nursery having a temperature 20-25° C., 1,200-2,000 m high above the sea level, covering about 90% of natural light, 85-90% air humidity in 10-20 days. These plants are kept dry and avoiding rainwater which can causes infections. Another embodiment of the invention is that using greenhouses or in laboratories to simulate the natural environment to grow the grafted Teak tree.

### Step 4: Sterilizing and Planting Grafted Teak Trees in Nurseries

The grafted Teak tree after being adapted to the environment is sprayed around the body with liquid Anolyte which is a liquid prepared from diluted saline liquid (0.5%) in an electrochemical reaction chamber with a diaphragm with two electrodes. From diluted saline liquid, after the activation process, two liquids Catholyte and Anolyte are obtained. Anolyte is the liquid obtained in the anodic chamber of the electrochemical reaction chamber, containing substances such as HOCl, NaOCl, H2O2, O+, hydroxyl and carbonates radicals, which are capable of oxidation highly and antiseptic. Liquid Anolyte has a bactericidal effect so it helps the baby tree avoid the damage caused by bacteria during the grafting phase and when the plant is introduced to the autotrophic environment. After the baby tree have been sterilized by liquid Anolyte, it is taken to plant in the nursery on porous humus soil with a pH of 6.5-7, air humidity maintained by the misting system to achieve 80-90%, height from 1,200-2,000 m high above sea level, covering 80-95% of natural light, temperature of 20-25° C. The degree of shading of natural light needs to be flexible by gradually reducing the coverage to allow plants to adapt to low cover conditions step by step. This seedling can also be grown at a distance of 20×20 cm in nursery pots containing suitable humus to facilitate field planting.

### Step 5: Moving the Grafted Teak Trees into Farms

After being adapted and grown in the nursery, the grafted Teak trees are planted in the farms. The farms for planting trees should be designed under the canopy of primeval forest, with 80-95% of covering natural light or artificially covered but it must ensure the natural light from 70-95%, keep the humidity in the range of 80-95%, about temperature of 20-25° C., 1,200 to 2,500 m high above sea level. Trees are grown on beds, porous soil, preferably meat soils mixed with leaves or soil taken on surface of the forest. The soil is made into beds and planted with a distance of 40×40 cm for easy storage and fertilization. In this step, one third of the lower leaves of each tree should be cuts down so that the trees can increase their height.

The method of planting brings advantages of seven species of grafted trees into the grafted Teak tree, including high survival rate, fast growth, straight and large diameter trunk, high quantity, light weight, waterproof, heat resistance and good resistance against termites, flexibility and fire resistance, adaptation to harsh soil conditions and bad climate.

1. A method of planting grafted Teak (Tectona grandis) trees, comprising:
preparing the seeds and creating initial Teak trees namely, seeds of initial Teak trees are stored in bags for soaking in 80-100 ° C. water within 14-15 hours, then, the seeds are taken out and washed to remove sour and dried under sunlight; the soaking and drying processes are repeated for 4 continuous days and then the prepared seeds are sown into bed soil in the beginning of the spring or the rain season; meanwhile, for creating initial Teak trees, bed soil is applied with about 4-5 kg/m² of manure before being sterilized by liquid Benlate 1% or liquid Bi58 1% and shall be watered about 1 liter/m² for 1-2 weeks before sowing; the seeds are sowed in 20 cm-apart slits, distance between seeds are 4-5 cm and then are fully covered by the soil; scattering method can be applied, however, it takes more grains and the baby trees need to be pruned to adjust density; depending on each area, straw or dry grass can be used to maintain moisture, if the straw or dry grass are not used, it is required to water the seeds twice a day; after sowing, the soil must be kept moist; then, the seeds shall germinate after about 1 month with a rate of 30-35%; water must be daily provided to maintain moisture, continuously for the first 1.5 months; then, water once per 2-3 days; clear weed and break clods 2 times/month, prune and move the baby trees from density place to sparse place; from the 6^{th} month to the 10^{th} month, water provide to ensure the moisture once a month; taking care for 2 months before planting; baby trees are resistant to pests and diseases, however, if pests and diseases appear, appropriate medicines in the market can be used;
grafting the baby Teak tree with 7 different species of trees, comprising Paulownia trees, Pine trees, Western white pine trees, Azobe trees, Red wood trees, White cedar trees, Soft maple trees to create grafted Teak trees;
taking care the grafted Teak tree so that they can adapt to the environment namely, the qualified baby grafted trees shall be brought to the nursery having a temperature 20-25° C., 1,200-2,000 m high above the sea level, covering about 90% of natural light, 85-90% air humidity in 10-20 days;
sterilizing and planting grafted Teak tree in nurseries namely, after the baby trees have been sterilized by liquid Anolyte, they are brought to the nursery and planted on porous humus soil with a pH of 6.5-7, air humidity maintained by the misting system to achieve 80-90%, 1,200-2,000 m above sea level, covering 80-95% of natural light, temperature 20-25° C.;
moving the grafted Teak tree into farms having 80-95% natural light or artificially covered with 70-95% of natural light, keep the humidity in the range of 80-95%, temperature 20-25° C., 1,200-2,500 m above sea level.
